(19) United States
(12) Patent Application Publication
(10) Pub. No.: US 2020/0391708 A1
(43) Pub. Date: Dec. 17, 2020

(54) AUTONOMOUS EMERGENCY BRAKING SYSTEM AND CONTROL METHOD THEREOF

(71) Applicant: MANDO CORPORATION, Pyeongtaek-si (KR)

(72) Inventor: Shanmugaraj MANI, Bangalore (IN)

(21) Appl. No.: 16/898,842

(22) Filed: Jun. 11, 2020

(30) Foreign Application Priority Data
Jun. 11, 2019 (KR) 10-2019-0068776

(51) Int. Cl. B60T 7/22; G06K 9/00

(52) U.S. Cl. CPC B60T 7/22; B60T 2210/32; G06K 9/00838

(57) ABSTRACT

An autonomous emergency braking system includes a rear camera configured to acquire a rear image information of the vehicle, a hydraulic unit configured to supply brake fluid pressure to a wheel brake provided on each wheel; and a controller configured to receive the rear image information obtained through the rear camera, detect a ground area in the received rear image, detect a child candidate object on the detected ground area, determines a feature vector of a shape of a child's posture for the detected child candidate object, and determine whether the child candidate object is a child by comparing the determined feature vector with a preset feature vector, and brake the vehicle emergently through the hydraulic unit when it is the child.

### CROSS-REFERENCE TO RELATED APPLICATION(S)

This application is based on and claims priority under 35 U.S.C. § 119 to Korean Patent Application No. 10-2019-0068776, filed on Jun. 11, 2019 in the Korean Intellectual Property Office, the disclosure of which is incorporated by reference in its entirety.

### BACKGROUND

### 1. Technical Field

Embodiments of the present disclosure relate to an autonomous emergency braking system and control method thereof, and more particularly, to the autonomous emergency braking system and control method thereof for automatically braking a vehicle when there is a danger of collision with an object.

### 2. Description of the Related Art

An accident may occur in which a driver hits a pedestrian by reversing the vehicle without knowing whether there is a pedestrian behind the vehicle.

Many of the injured victims are known to be children.

Rear cameras have been proven effective in preventing backward collisions with pedestrians.

However, simply showing the rear image to the driver is not perfect to prevent pedestrian accidents during reversing. In fact, studies have shown that even when using a rear view camera, the driver has a high probability of avoiding a child-sized mannequin and causing a collision.

In addition, the front pedestrian is mainly a standing posture, but the rear pedestrian takes various postures such as a sitting or creeping posture as well as a standing posture.

Previously, the focus was on the technology of detecting forward pedestrians, especially those standing in an upright standing position. For this reason, it is difficult to detect rear pedestrians in various postures such as sitting or creeping postures, especially in children.

In addition, since the rear pedestrian is located at a very close distance to the vehicle, it is difficult to prevent a backward collision due to the limitation of rapid braking in the driver's position where the reaction time is limited.

### SUMMARY

In view of the above, it is an aspect of the present disclosure to provide an autonomous emergency braking system and control method thereof for detecting children in various postures at the rear of a vehicle and preventing collision with children.

In accordance with an aspect of the present disclosure, an autonomous emergency braking system includes a rear camera configured to acquire a rear image information of the vehicle; a hydraulic unit configured to supply brake fluid pressure to a wheel brake provided on each wheel; and a controller configured to receive the rear image information obtained through the rear camera, detect a ground area in the received rear image, detect a child candidate object on the detected ground area, determines a feature vector of a shape of a child's posture for the detected child candidate object, and determine whether the child candidate object is a child by comparing the determined feature vector with a preset feature vector, and brake the vehicle emergently through the hydraulic unit when it is the child.

The controller may determine whether the child candidate object is a child based on an average width and height of the child and whether or not it is connected to the detected ground area.

The controller may determine whether the child candidate object is the child by comparing a feature vector of a child in a sitting or creeping position with a preset feature vector.

The controller may detect edges in a vertical/horizontal/diagonal direction among the edges for the detected child candidate object, aligns and compare shapes formed by the detected edges and a reference shapes in the vertical/horizontal/diagonal direction of various preset postures of child, and determine the child candidate object as the child when a similarity between the two shapes is greater than or equal to a threshold.

The controller may determine a possibility of collision between the vehicle and the child based on the determined distance between the child and the vehicle, and urgently brakes the vehicle based on the determination result.

In accordance with another aspect of present disclosure, the control method of an autonomous emergency braking system comprises: acquiring a rear image information of a vehicle through a rear camera; detecting a ground area in the received rear image; detecting a child candidate object on the detected ground area; determining a feature vector of a shape of a child's posture for the detected child candidate object; determining whether the child candidate object is a child by comparing the determined feature vector with a preset feature vector; and braking the vehicle emergently through the hydraulic unit when it is the child.

Determining whether the child candidate object is the child may comprise determining whether the child candidate object is a child based on an average width and height of the child and whether or not it is connected to the detected ground area.

Determining whether the child candidate object is the child may comprise determining whether the child candidate object is the child by comparing a feature vector of a child in a sitting or creeping position with a preset feature vector.

Determining whether the child candidate object is the child may comprise detecting edges in a vertical/horizontal/diagonal direction among the edges for the detected child candidate object, aligning and comparing shapes formed by the detected edges and a reference shapes in the vertical/horizontal/diagonal direction of various preset postures of child, and determining the child candidate object as the child when a similarity between the two shapes is greater than or equal to a threshold.

Braking the vehicle emergently may comprise: determining a possibility of collision between the vehicle and the child based on the determined distance between the child and the vehicle, and urgently braking the vehicle based on the determination result.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 illustrates a configuration of a vehicle including an autonomous emergency braking system according to an embodiment.

FIG. 2 illustrates a control block diagram of an autonomous emergency braking system according to an embodiment.

FIG. 3 illustrates an image taken from the rear of a vehicle through a rear camera in an autonomous emergency braking system according to an embodiment.

FIGS. 4 to 8 illustrates a process of detecting a child in a sitting position behind a vehicle in an autonomous emergency braking system according to an embodiment.

FIG. 9 illustrates a diagram for detecting a child in a posture of crawling behind a vehicle in an autonomous emergency braking system according to an embodiment.

FIG. 10 illustrates a control method of an autonomous emergency braking system according to an embodiment.

### DETAILED DESCRIPTION

Reference will now be made in detail to the embodiments of the present disclosure, examples of which are illustrated in the accompanying drawings, wherein like reference numerals refer to like elements throughout. This specification does not describe all elements of the embodiments of the present disclosure and detailed descriptions on what are well known in the art or redundant descriptions on substantially the same configurations may be omitted. The terms ‘unit, module, member, and block’ used herein may be implemented using a software or hardware component. According to an embodiment, a plurality of ‘units, modules, members, or blocks’ may also be implemented using an element and one ‘unit, module, member, or block’ may include a plurality of elements.

Throughout the specification, when an element is referred to as being “connected to” another element, it may be directly or indirectly connected to the other element and the “indirectly connected to” includes being connected to the other element via a wireless communication network.

Also, it is to be understood that the terms “include” and “have” are intended to indicate the existence of elements disclosed in the specification, and are not intended to preclude the possibility that one or more other elements may exist or may be added.

Throughout the specification, when one member is positioned “on” another member, this includes not only the case where one member is in contact with the other member but also another member between the two members.

The terms first, second, etc. are used to distinguish one component from another component, and the component is not limited by the terms described above. An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

According to one aspect of the disclosed embodiment, it is possible to more effectively detect a child at the rear of the vehicle and prevent collision with the child through automatic braking.

According to one aspect of the disclosed embodiment, a child may be detected even in various postures such as a child's sitting or crawling posture.

The autonomous emergency braking system according to an embodiment is a system in which a vehicle detects a danger in advance when a pedestrian is detected using a camera mounted on the vehicle and automatically controls a brake when the driver fails to react to prevent a collision.

In addition, the autonomous emergency braking system detects pedestrians to prevent collision with pedestrians. The collision with the pedestrian can be prevented in advance by automatically performing the sudden braking regardless of whether the driver is braking based on the relative speed and the relative distance.

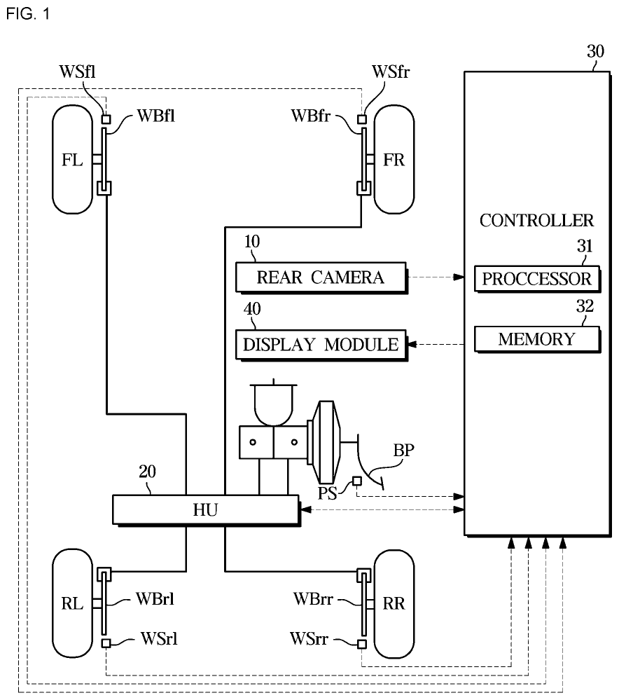

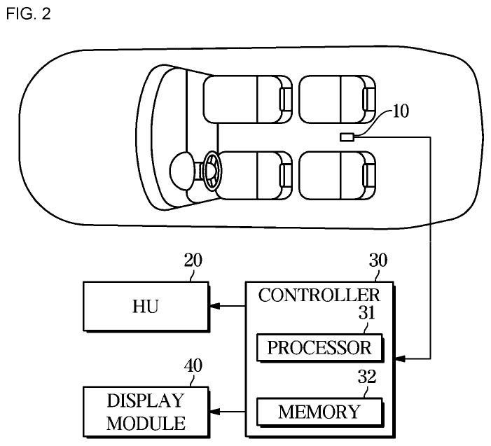

FIG. 1 illustrates a configuration of a vehicle including an autonomous emergency braking system according to an embodiment, and FIG. 2 illustrates a control block diagram of an autonomous emergency braking system according to an embodiment.

Referring to FIG. 1 and FIG. 2, the autonomous emergency braking system may include a rear camera 10, hydraulic unit 20, controller 30 and display module 40.

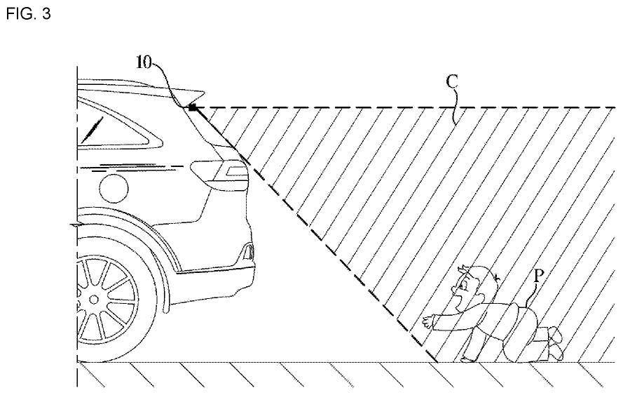

The rear camera 10 may be configured by a camera mounted on the lower surface of the rear side of the roof panel and capable of capturing the rear of the vehicle body as a still image or a video through the rear windshield. The rear camera 10 may acquire image information at the rear of the vehicle to capture a pedestrian P such as a child in the capture area C at the rear of the vehicle (See FIG. 3).

The rear camera 10 may include a CCD (Charge-Coupled Device) camera or a CMOS color image sensor. Here, both CCD and CMOS refer to a sensor that converts and stores light coming through the camera's lens into an electrical signal. Specifically, a CCD (Charge-Coupled Device) camera is a device that converts an image into an electrical signal using a charge-coupled device. In addition, CIS (CMOS Image Sensor) means a low-consumption, low-power imaging device having a CMOS structure, and serves as an electronic film for digital devices. In general, the CCD has a higher sensitivity than the CIS, and is often used in the vehicle 1, but is not necessarily limited thereto.

The hydraulic unit (HU) 20 may supply brake fluid pressure to the wheel brakes WBfl, WBrr, WBrl, and WBfr to impart braking force to each wheel FL, RR, RL, FR.

The hydraulic unit 20 includes a hydraulic pump that pumps the brake fluid from the reservoir and supplies it to each wheel cylinder (Wfr, Wrl, Wfl, Wrr), a motor connected to this hydraulic pump, a low pressure accumulator for temporarily storing brake fluid pumped by the hydraulic pump, solenoid valves that supply the brake fluid supplied from the master cylinder to the wheel cylinder or return to the reservoir. In addition, hydraulic unit 20 can be implemented in various forms.

The controller 30 may include a processor 31 and a memory 32.

The processor 31 may receive operation information of the driver operating the brake pedal BP through the brake pedal sensor PS.

The processor 31 may receive wheel speed information from wheel speed sensors WSfl, WSrr, WSrl, and WSfr, which are provided on each wheel FL, RR, RL, FR, and detect wheel speeds of each wheel, respectively. The processor 31 may recognize the speed of the vehicle 1 according to each wheel speed information detected through the wheel speed sensors WSfl, WSrr, WSrl, and WSfr.

The processor 31 operates the wheel brakes WBfl, WBrr, WBrl, and WBfr provided on each wheel FL, RR, RL, FR through the hydraulic unit HU 20 to operate each wheel FL, RR, RL, FR.

The processor 31 can process the output of the rear camera 10 and urgently brake the vehicle 1 through the hydraulic unit 20 based on the output of the rear camera.

The processor 31 may detect information in the rear image of the vehicle obtained by the rear camera 10. The information may be information about pedestrians. The information may be information about children among pedestrians. The information may be various posture information of the child.

The processor 31 analyzes the image information obtained through the rear camera 10 to detect children in various postures such as standing, sitting or creeping postures, and when the child is present, the vehicle may be braked urgently.

The processor 31 analyzes the image information obtained through the rear camera 10 to detect the ground, detect the detected object on the ground, determine whether it is a child of various postures such as a sitting or creeping posture, and brakes the vehicle urgently when the determined as the child.

The processor 31 may determine the possibility of collision between the vehicle and the child based on the distance between the child and the vehicle, and if the possibility of collision is greater than a preset value, the vehicle may urgently brake the vehicle.

The memory 32 may store programs and data for processing the output of the rear camera, programs and data for detecting children of various postures in the rear image, and programs and data for urgently braking the vehicle 1.

The memory 32 may temporarily store the image data received from the rear camera 10, and temporarily store the result of processing the image data of the processor 31.

The memory 32 includes a volatile memory such as S-RAM and D-RAM as well as a non-volatile memory such as flash memory, ROM (Read Only Memory, ROM), Erasable Programmable Read Only Memory (EPROM).

The display module 40 may display a rear image obtained through the rear camera 10 by the processor 31.

The display module 40 may display the children separately in the rear image so that the driver can visually check by the processor 31.

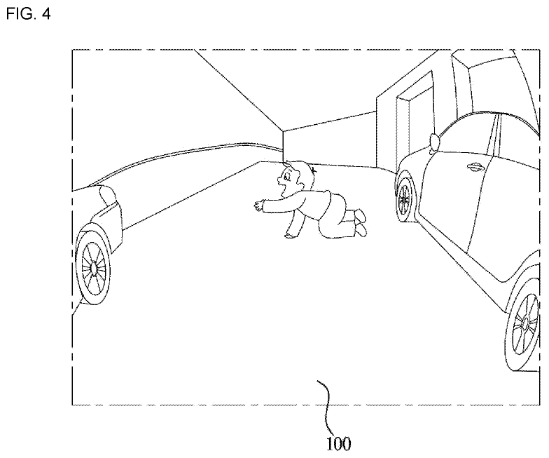

FIGS. 4 to 7 illustrates a process of detecting a child in a sitting position behind a vehicle in an autonomous emergency braking system according to an embodiment.

As shown in FIG. 4, the processor 31 receives a vehicle rear image through the rear camera 10.

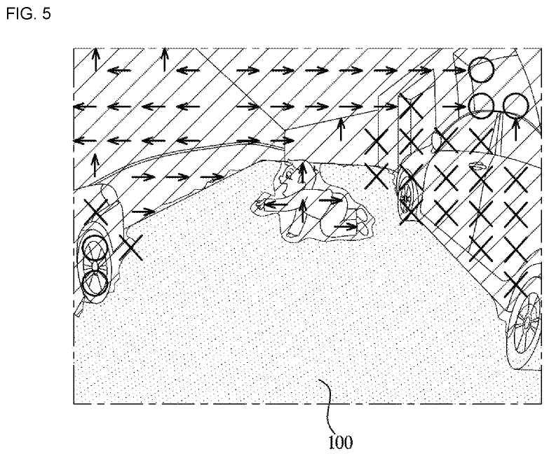

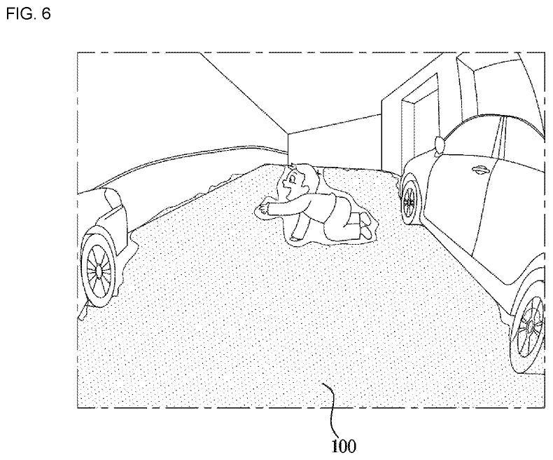

As shown in FIGS. 5 and 6, the processor 31 detects the ground area 100 from the received vehicle rear image.

The processor 31 may detect an edge (or boundary) in the rear image of the vehicle received from the rear camera 10 to detect the ground area 100 divided by the edge.

The processor 31 uses an edge detection algorithm such as a Canny edge detection algorithm, a line edge detection algorithm, and a Laplacian edge detection algorithm to detect boundary lines in an image and extract the ground area 100.

The processor 31 may group regions separated from the background according to the detected boundary lines and extract them as ground regions.

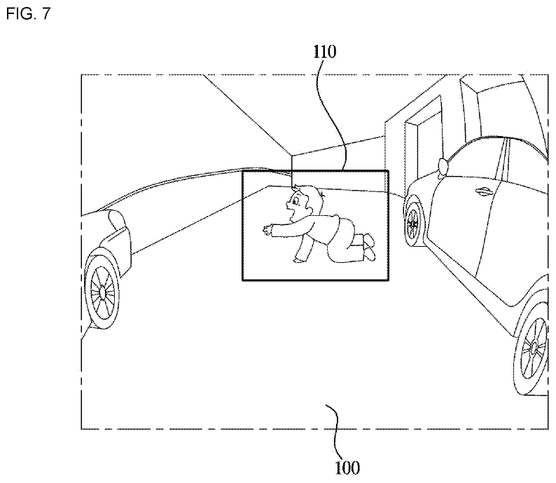

As illustrated in FIG. 7, the processor 31 detects a child candidate object 110 on the ground area 100.

The processor 31, the child candidate object 110 may include both dynamic objects and static objects.

The processor 31 may extract the child candidate object 110 based on the color difference between the background and the object. The processor 31 may calculate a pixel value of the vehicle rear image to group regions having similar color values and extract one group as one object. The pixels of the object may be grouped into one region based on characteristics having similar color values to each other.

The processor 31 estimates a motion vector representing motion information from changes in contrast between two adjacent image frames among the received rear images, and detects a child candidate object 110 according to the direction and size of the feature point movement from the estimated motion vector.

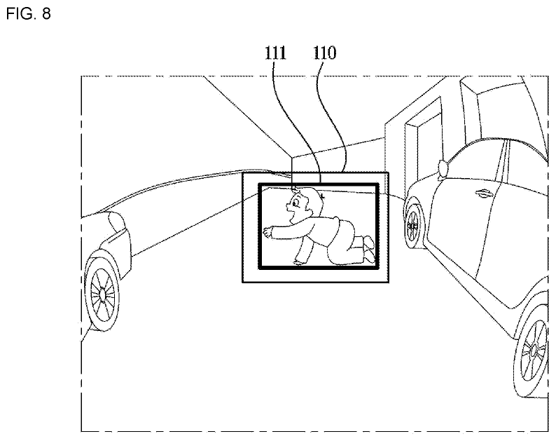

As shown in FIG. 8, the processor 31 detects the child 111 from the child candidate object 110 detected on the ground area 100.

The processor 31 may determine a feature vector related to a child's posture for the child candidate object 110 and compare the determined feature vector with a preset feature vector to determine whether the child candidate object 110 is the child 111.

The processor 31 may determine whether the child candidate object 110 is the child 111 based on the average width and height of the child candidate object 110, whether it is connected to the ground, etc. in consideration of the sitting or creeping posture of the child.

The processor 31 may determine whether the child candidate object 110 is the child 111 based on a child's sitting or creeping posture feature and a specific feature of the child corresponding to the posture size feature.

The processor 31 may determine whether the child candidate object is the child 111 by detecting the vertical component for the child candidate object 110 and determining the similarity between the detected vertical component and the child pattern.

The processor 31 detects vertical edges among the edges for the child candidate object 110, aligns and compares the shapes formed by the detected edges and the reference shapes in the vertical direction of various postures of a child stored in a predetermined table, and detects the child candidate object 110 as the child 111 when the similarity between the two shapes is greater than or equal to the threshold.

The processor 31 detects edges in the vertical/horizontal/diagonal direction among the edges for the child candidate object 110, aligns and compares the shapes formed by the detected edges and the reference shapes in the vertical/horizontal/diagonal directions of various postures of a child stored in a predetermined table, and detects the child candidate object 110 as the child 111 when the similarity between the two shapes is greater than or equal to the threshold.

When a child is detected, the processor 31 may display the child separately in the rear image through the display module 40.

The autonomous emergency braking system according to an embodiment pre-trains various postures such as a child's sitting position and a creeping posture using a SVM (Support Vector Machine) classifier, and then determines whether the child candidate object 110 is a child 111 in the rear image.

Autonomous emergency braking system according to an embodiment can determine whether the child candidate object 110 is a child 111 or not by the SVM (Support Vector Machine) technique, or an identification method using a neural network, a technique identified by AdaBoost using Haar-like features, or a HOG (Histograms of Oriented Gradients) technique, an optical flow estimation algorithm, etc.

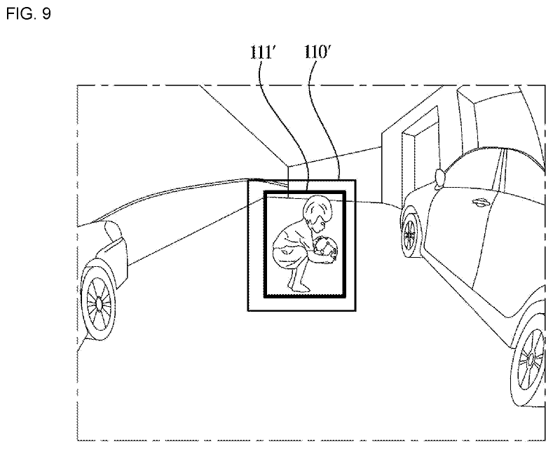

FIG. 9 illustrates a diagram for detecting a child in a posture of crawling behind a vehicle in an autonomous emergency braking system according to an embodiment.

In this way, even if a child sits or creeps in the back of the vehicle, the child can be detected, and when the risk of collision is high, the vehicle can be emergently braked to prevent collision with the child.

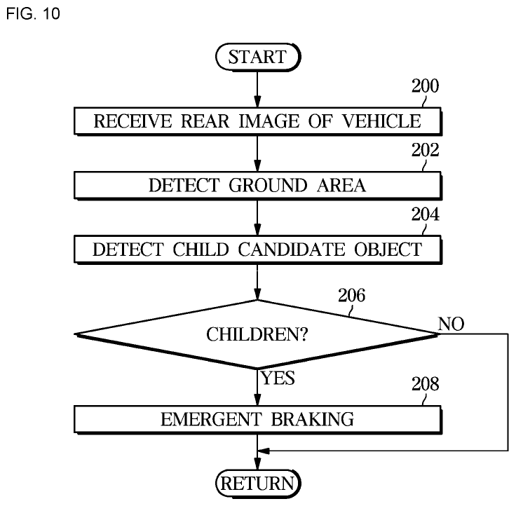

FIG. 10 illustrates a control method of an autonomous emergency braking system according to an embodiment.

Referring to FIG. 10, the processor 31 receives a vehicle rear image from the rear camera 10 (200).

The processor 31 analyzes the received vehicle rear image to detect the ground area 100 (202). The processor 31 may detect an edge in the rear image of the vehicle received from the rear camera 10 to detect the ground area 100 divided by the edge. The processor 31 detects the child candidate object 110 in the detected ground area 100 (204). The processor 31 may detect the child candidate 110 using the area grouped into one area having similar color values by calculating pixel values of the vehicle rear image.

The processor 31 determines whether the child candidate object 110 is the child 111 by determining the feature vector of the child posture shape for the child candidate object 110 and comparing the determined feature vector with a preset feature vector (206). Processor 31 may determine whether the child candidate object 110 is a child 111 by using SVM (Support Vector Machine) classification identification method, neural network (neural network) identification method, Haar-like feature using AdaBoost identification method, or HOG (Histograms of Oriented Gradients) method, optical flow estimation algorithm, etc.

When the child candidate object 110 is the child 111, the processor 31 urgently brakes the vehicle through the hydraulic unit 20 (208).

The aforementioned controller and/or the components thereof may include one or more processors/microprocessors coupled with a computer readable recording medium storing computer readable code/algorithm/software. The processor(s)/microprocessor(s) may perform the above described functions, operations, steps, etc., by executing the computer readable code/algorithm/software stored on the computer readable recording medium.

The aforementioned controller and/or the components thereof may be provided with, or further include, a memory implemented as a non-transitory computer readable recording medium or a transitory computer readable recording medium. The memory may be controlled by the aforementioned controller and/or the components thereof, and be configured to store data transmitted to/from the aforementioned controller and/or the components thereof or configured to store data processed or to be processed by the aforementioned controller and/or the components thereof.

The present disclosure can also be embodied as computer readable code/algorithm/software stored on a computer readable recording medium. The computer readable recording medium may be a non-transitory computer readable recording medium such as a data storage device that can store data which can thereafter be read by a processor/microprocessor. Examples of the computer readable recording medium include a hard disk drive (HDD), a solid state drive (SSD), a silicon disc drive (SDD), read-only memory (ROM), CD-ROM, magnetic tapes, floppy disks, optical data storage devices, etc.

### DESCRIPTION OF SYMBOLS

| | |
|---|---|
| 10: rear camera | 20: hydraulic unit |
| 30: controller | 31: processor |
| 32: memory | 40: display module |

What is claimed is:

1. An autonomous emergency braking system comprising:
a rear camera configured to acquire a rear image information of the vehicle;
a hydraulic unit configured to supply brake fluid pressure to a wheel brake provided on each wheel; and
a controller configured to receive the rear image information obtained through the rear camera, detect a ground area in the received rear image, detect a child candidate object on the detected ground area, determines a feature vector of a shape of a child's posture for the detected child candidate object, and determine whether the child candidate object is a child by comparing the determined feature vector with a preset feature vector, and brake the vehicle emergently through the hydraulic unit when it is the child.

2. The autonomous emergency braking system according to claim 1, wherein the controller determines whether the child candidate object is a child based on an average width and height of the child and whether or not it is connected to the detected ground area.

3. The autonomous emergency braking system according to claim 2, wherein the controller determines whether the child candidate object is the child by comparing a feature vector of a child in a sitting or creeping position with a preset feature vector.

4. The autonomous emergency braking system according to claim 1, wherein the controller detects edges in a vertical/horizontal/diagonal direction among the edges for the detected child candidate object, aligns and compares shapes formed by the detected edges and a reference shapes in the vertical/horizontal/diagonal direction of various preset postures of child, and determines the child candidate object as the child when a similarity between the two shapes is greater than or equal to a threshold.

5. The autonomous emergency braking system according to claim 1, wherein the controller determines a possibility of collision between the vehicle and the child based on the determined distance between the child and the vehicle, and urgently brakes the vehicle based on the determination result.

6. A control method of an autonomous emergency braking system comprising:
acquiring a rear image information of a vehicle through a rear camera;
detecting a ground area in the received rear image;
detecting a child candidate object on the detected ground area;
determining a feature vector of a shape of a child's posture for the detected child candidate object;
determining whether the child candidate object is a child by comparing the determined feature vector with a preset feature vector; and
braking the vehicle emergently through the hydraulic unit when it is the child.

7. The control method of claim 6, wherein determining whether the child candidate object is the child comprises determining whether the child candidate object is a child based on an average width and height of the child and whether or not it is connected to the detected ground area.

8. The control method of claim 7, wherein determining whether the child candidate object is the child comprises, determining whether the child candidate object is the child by comparing a feature vector of a child in a sitting or creeping position with a preset feature vector.

9. The control method of claim 6, wherein determining whether the child candidate object is the child comprises, detecting edges in a vertical/horizontal/diagonal direction among the edges for the detected child candidate object, aligning and comparing shapes formed by the detected edges and a reference shapes in the vertical/horizontal/diagonal direction of various preset postures of child, and determining the child candidate object as the child when a similarity between the two shapes is greater than or equal to a threshold.

10. The control method of claim 6, wherein braking the vehicle emergently comprises: determining a possibility of collision between the vehicle and the child based on the determined distance between the child and the vehicle, and urgently braking the vehicle based on the determination result.

11. A non-transitory computer-readable medium storing computer-executable instructions, when executed by a processor, causing the processor to perform the method of claim 6.
